(19) United States
(12) Patent Application Publication
(10) Pub. No.: US 2009/0254624 A1
(43) Pub. Date: Oct. 8, 2009

(54) E-MAIL MESSAGE MANAGEMENT SYSTEM

(76) Inventors: JEFF BAUDIN, SANTA ROSA, CA (US); JEAN-FRANCOIS DUCORROZ, SONOMA, CA (US)

Correspondence Address: STAINBROOK & STAINBROOK, LLP, 412 AVIATION BOULEVARD, SUITE H, SANTA ROSA, CA, 95403, US

(21) Appl. No.: 12/420,667

(22) Filed: Apr. 8, 2009

Related U.S. Application Data
(60) Provisional application No. 61/043,357, filed on Apr. 8, 2008.

(51) Int. Cl. G06F 15/16

(52) U.S. Cl. 709/206; 707/10; 707/E17.032

(57) ABSTRACT

An e-mail program having a message deferment feature for postponing the time for taking action on incoming mail message until a specified future time, an auto-filing feature, a find similar feature, a message tokenizing features, and a suggest reply feature.

### CROSS REFERENCES TO RELATED APPLICATIONS

The present application claims the benefit of U.S. Provisional Patent Application Ser. No. 61/043,357, filed Apr. 8, 2008 (04/08/2009).

### SEQUENCE LISTING

Not applicable.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

### Field of the Invention

The present invention relates generally to computer programs for communicating over a global computer network, and more particularly to e-mail programs, and still more particularly to an e-mail program having several novel features that add convenience, ease of use, and power in organizing received and sent e-mail.

### BRIEF SUMMARY OF THE INVENTION

The present invention comprises, among its various embodiments, methods and systems for handling incoming e-mail in an e-mail client program.

It is therefore an object of the present invention to provide a new and improved e-mail management and organization system.

It is another object of the present invention to provide a new and improved e-mail message management system that includes a message deferment feature for postponing the time for taking action on incoming mail message until a specified future time.

It is still another object of the present invention to reduce clutter in an e-mail program Inbox.

Still another object of the present invention is to provide an improved e-mail message management system that

Yet another object of the present invention is to provide an e-mail message management system that automatically suggests folders to which a user may wish to file an e-mail message.

A still further object of the present invention is to provide an e-mail system that includes a “find-similar” function for finding messages similar to a source message.

Yet another object of the present invention is to provide an e-mail message management system that automatically suggests reply text for a specified message.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty that characterize the invention are pointed out with particularity in the claims annexed to and forming part of this disclosure. The invention does not reside in any one of these features taken alone, but rather in the particular combination of all of its structures for the functions specified.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of the claims appended hereto.

### BRIEF DESCRIPTION OF THE SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a schematic block diagram showing the telecommunications infrastructure in which an e-mail sending computer and an e-mail receiving computer communicate with one another through a global communications network;

FIG. 2A is a schematic flow diagram showing the message deferral feature of the present invention;

FIG. 2B is a flow diagram showing the message deferment cancellation task of the present invention;

FIG. 2C is a flow diagram showing the message deferment clearing feature of the present invention;

FIG. 2D is a flow diagram showing the task for processing remote IMAP deferment commands;

FIG. 3 is a flow diagram showing the auto-filing task of the present invention;

FIG. 4A is a flow diagram showing the message tokenizing process of the present invention;

FIG. 4B is a flow diagram showing the method steps of the find similar message task;

FIG. 5 is a flow diagram showing the auto-reply task; and

FIG. 6 is a flow diagram setting out the method steps of the mail account icon task of the e-mail program of the present invention.

### DESCRIPTION OF THE INVENTION

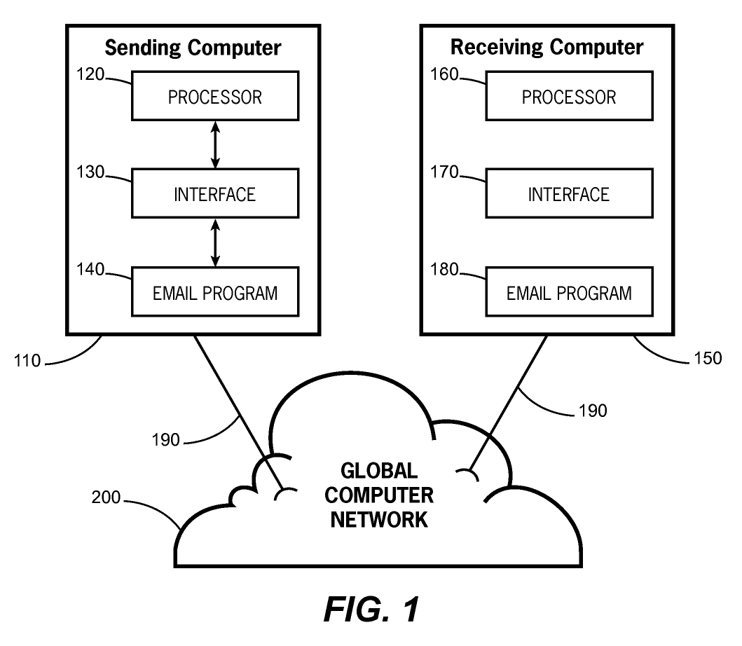

Referring to FIGS. 1 through 6, there is illustrated therein a new and improved e-mail program. FIG. 1A is a schematic block diagram showing a global computer network 100 in which the preferred embodiments of the present invention can be practiced. In its simplest and most essential form, computer network includes an e-mail sending computer 110 consisting of a processor 120 with a user interface 130 for input and output and an operating e-mail program 140. It next includes an e-mail receiving computer 150, also consisting of a processor 160, user interface 170, and an operating e-mail program 180. The operating system may be one of many kinds, including Microsoft Windows, Linux, Unix or Unix-like, BSD, Solaris, Mac OS, and so on.

Each of the sending and receiving computers is provided with a network communications link or mechanism 190 with which to connect to the global computer network (e.g, the Internet) 200 and through which to send and receive e-mail messages. It is also to be understood, moreover, that by “computer” is meant any network connecting device capable of sending and receiving messages using an e-mail program protocol, which may include, without limitation, personal computers, laptop computers, cell phones, personal data assistants, network connected multimedia playback devices, and so forth.

FIG. 1B is a schematic flow diagram showing the Message Deferment feature of the inventive e-mail program. Briefly, this is a method for postponing the time for taking action on incoming mail message until a specified future time. This method is directed to the problem routinely experienced by e-mail users who often receive e-mail messages that cannot be acted on immediately. Such messages are usually left to accumulate in the Inbox folder of the user's e-mail client, thus cluttering the Inbox. The Message Deferment feature helps manage this problem by allowing a user to postpone taking action on incoming messages while reducing clutter in the Inbox. Messages in the Inbox may be deferred for an amount of time specified by the user. When a message is deferred it is removed from the Inbox and placed in a special Deferred mailbox where it will remain until the deferment time expires. When the time expires the message is automatically moved back to the Inbox and marked as unread so that it will be brought to the user's attention. The user may then take action on the message or defer it again. Message deferments may be cancelled at any time. When a deferment is cancelled, the associated message is moved back to the Inbox. Messages that have been deferred are marked graphically to indicate the number of times they have been deferred. For IMAP accounts, message deferment information is stored in a special folder on the IMAP server so that e-mail clients on remote computers sharing the same IMAP account will be notified of message deferment actions.

The steps of the inventive Message Deferment features are as follows: At block 210 a message arrives in the receiving e-mail user's Inbox, and the user decides at block 220 to postpone action on it. The user selects the deferment time at block 230 whereupon the message's deferment time field in the database is updated with the user-selected deferment time. The message's deferment count in the database is also incremented. The deferred message is moved from the Inbox to the Deferred mailbox 240. At decision block 250, if the account is an Internet Message Access Protocol (IMAP) account, a special command message is created and saved in a special IMAP client synchronization mailbox 260. The command message indicates that it is a defer command and identifies the message being deferred, the message's deferment time and its updated deferment count. If at decision block 250, the account is identified as not being an IMAP account, then block 260 is bypassed at block 270.

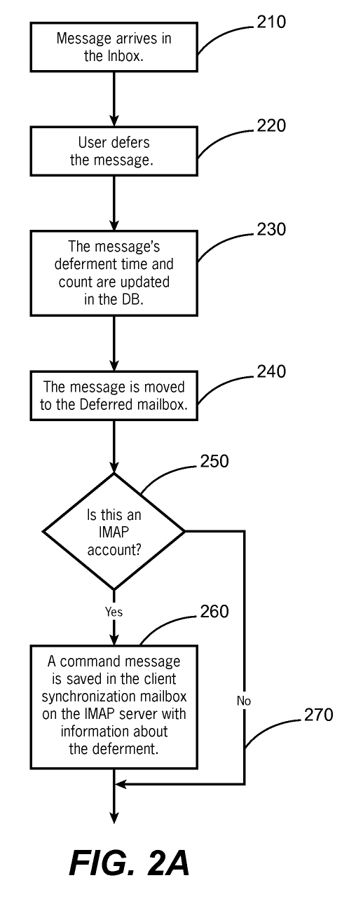

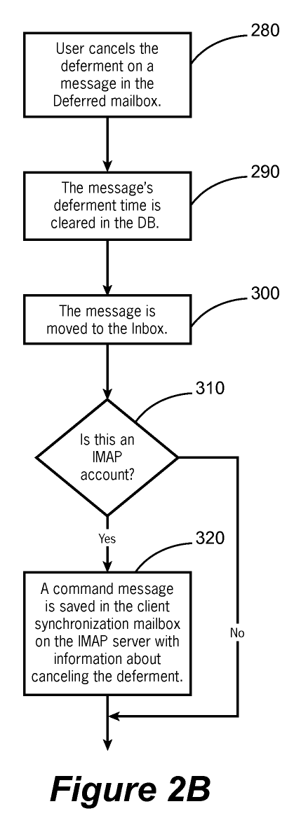

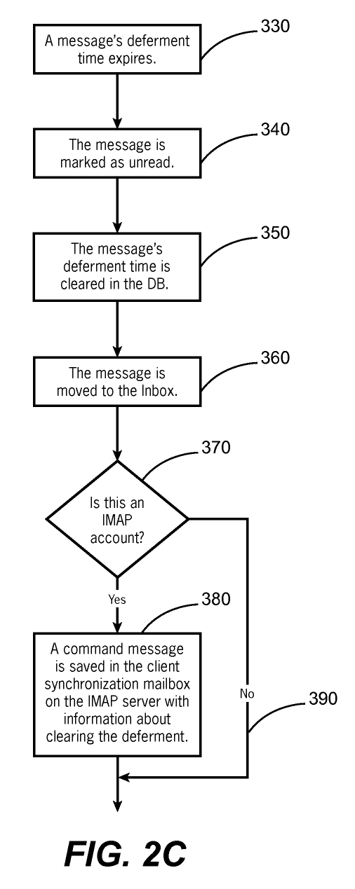

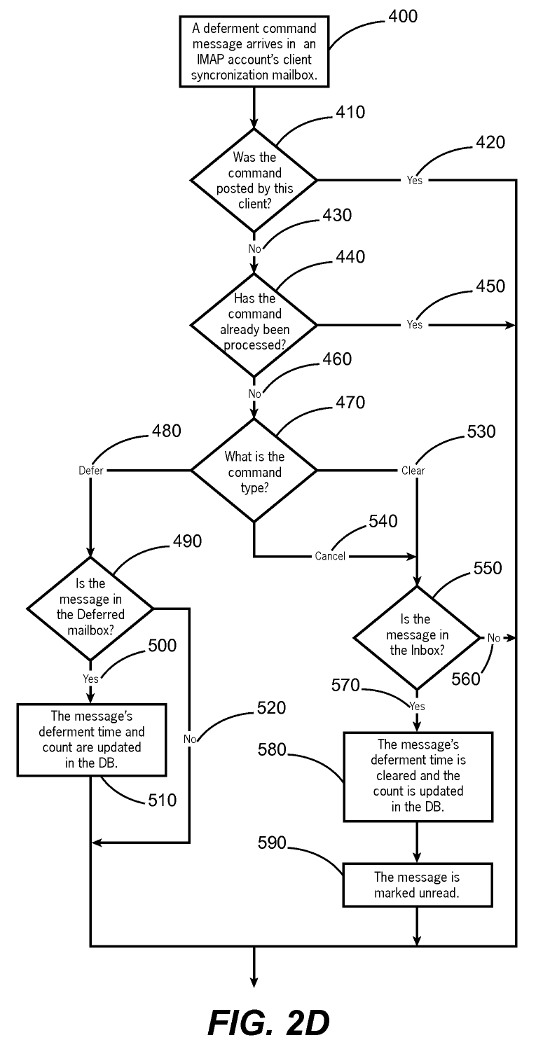

FIG. 2B shows the steps by which message deferments are cancelled. The user decides to cancel the deferment on a deferred message. The user selects the message in the Deferred mailbox and initiates the process 280. The message's deferment time in the database is cleared 290. The message is next moved back to the Inbox 300. At decision block 310, if the account is identified as an IMAP account, a special command message is created and saved in the special IMAP client synchronization mailbox 320. The command message indicates that it is a cancel-deferment command, identifies the message whose deferment is being cancelled and includes the message's updated deferment count. If is identified as not an IMAP account, step 320 is bypassed.

FIG. 2C is a schematic diagram showing the process by which a deferred message is brought back to the user's attention when its deferment time expires. A background task periodically checks the deferment times of the messages stored in the Deferred mailbox. When a message deferment time arrives 330, the message is marked as unread 340, its deferment time field in the database is cleared 350 and the message is moved to the Inbox 360. At decision block 370, if the account is identified as an IMAP account 380, a special command message is created and saved in the special IMAP client synchronization mailbox 390. The command message indicates that it is a “clear-deferment” command, identifies the message with a deferment being cleared, and includes an updated deferment count for the message. If the account is identified as not being an IMAP account, step 390 is bypassed.

FIG. 2D is a schematic flow diagram showing how the e-mail client of the inventive e-mail program processes remote deferment commands for its IMAP accounts. For each IMAP account, a background task periodically checks for command messages in the special IMAP client synchronization mailbox 400. At decision block 410, each command message is checked to see whether or not it was posted by the current client. If it was, the command is not processed 420. If it was not 430, the program checks 440 to see if the command has already been processed. If it has 450, it is not processed again. If it has not 460, the command is checked 470 to determine the kind of deferment presented, which include: defer, cancel deferment, and clear deferment.

Still referring to FIG. 2D, if the command is identified as a defer command 480, the task for processing remote IMAP commands looks 490 to see whether the message is in the Deferred mailbox, where it was initially moved by the client that posted the command. If it is found there 500, the database is updated 510 so that the message deferment time and deferment count fields match the values found in the command message. If it is not found there 520, step 510 is bypassed.

In a preferred embodiment, if at decision block 470 the command type is identified as either a clear-deferment command or a cancel-deferment command, the message is treated in the same manner. Thus, if at block 470 the command is a clear or cancel, 530, 540, respectively, the task looks 550 in the Inbox for the message whose deferment is either being cleared or cancelled. This is where it was moved by the client that posted the command. If it is not found 560, no further action is taken at this stage. If it is found 570, the database is updated 580 so that the message's deferment time field is cleared and its deferment count field is updated to match the value found in the command message. The message is also marked as unread 590.

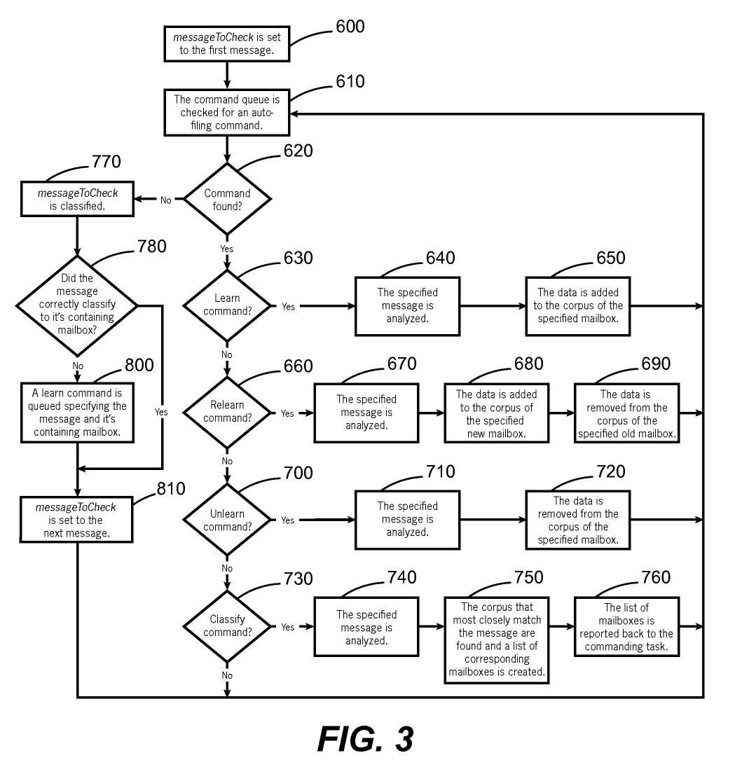

FIG. 3 shows the feature, or task, by which the inventive e-mail program automatically suggests folders to which a user may wish to file an e-mail message, thus facilitating fast filing. Users who file e-mail messages into folders generally follow a pattern. The folders become message categories. The Auto-Filing feature of the present invention allows the user to quickly file incoming e-mail messages based on a discernible pattern of categorization. Over time the program learns the user's filing habits by statistically analyzing the messages in the user's folders. It will then analyze incoming messages to determine which category or categories to which they most likely belong. It then suggests folders corresponding to the categories where it thinks the user would want to file a new message. It provides buttons by which the user can quickly file the message to one of the suggested folders thus freeing the user from having to drag-and-drop or navigate menus. The auto-filing task runs continuously in the background processes auto-file commands. These commands are: (1) learn, (2) relearn, (3) unlearn, and (4) classify. In addition, when there are no commands to process the task attempts to “get smarter” by checking all the messages it knows about to make sure they correctly classify to their containing mailboxes. If they do not, they are learned to their respective mailbox corpora again.

FIG. 3 is a schematic flow diagram showing how the auto-filing task of the inventive program processes commands as well as how it rechecks existing message for correct classifications. When a user sends or receives a message, it is set 600 to the first message. The task next checks 610 to see if the command queue contains an auto-filing command. If yes 620, a learn command 630 is sent to the task when a message has been copied to a mailbox. The task performs a statistical analysis 640 on the message and the results are added 650 to the corpus data file corresponding to the mailbox.

If the message was not copied to a mailbox but instead moved from one mailbox to another, a relearn command is sent 660 to the task when a message has been moved from one mailbox to another. The task then performs a statistical analysis 670 on the message and the results are added 680 to the corpus data file corresponding to the destination mailbox, and the results are removed 690 from the corpus data file corresponding to the source mailbox.

An unlearn command is sent 700 to the task when the client wishes to forget all about a message. The task performs a statistical analysis 710 on the message and the results are removed 720 from the corpus data file corresponding to the mailbox. Note that this does not necessarily occur when a message is deleted because even though the user may no longer need the message itself, we want to remember how it was filed so that similar messages will classify the same way.

A classify command is sent 730 to the task when the client wants to know how a message should be auto-filed. The task performs a statistical analysis 740 on the message and the results are compared 750 to that stored in the various corpus data files. A list of the closest matching mailboxes is returned 760 to the requesting task. The size of the list is configurable and communicated to the auto-filing task by the requester.

When there are no commands to process 770, the message is checked 780 made by the auto-filing task to ensure it classifies to the containing mailbox. If it does not 790, it is learned 800 and set to the containing mailbox again and the message to check is set 810 to the next message.

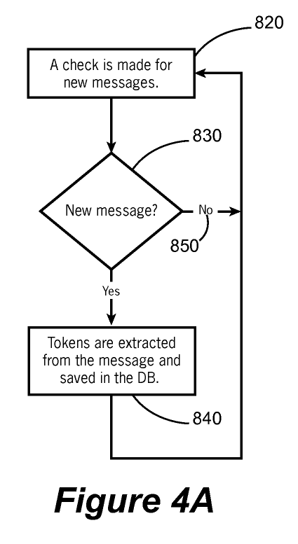

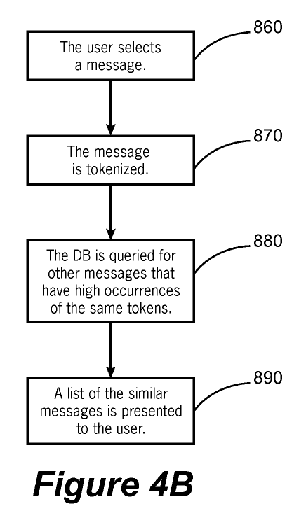

Two additional features of the inventive e-mail program are denominated the “Find Similar” and “Messages Tokenizing” features, respectively. The message tokenizing feature task is schematically illustrated in FIG. 4A. It provides a way for users with a large number of saved messages to quickly find messages that are similar to a source message. Similarity is based on the occurrence of common words that appear in the bodies of the messages. Messages that are similar to the source message are listed for quick viewing. A similar message may then be selected as the new source and the Find Similar feature can be used again to find messages similar to it. This process can continue as long as the user wishes, and the user can navigate through the hierarchy of results created by the process.

In FIG. 4A, we see that the client maintains a database of words and other tokens that occur in messages. It includes the number of times the tokens occur and in what messages they occur. The task routinely checks 820 for new messages. As a new message arrives 830, a background task extracts tokens from the new message and adds them 840 to the database. If the message is identified as not new 850, step 830 is bypassed.

FIG. 4B sets out the method steps of the Find Similar task of the e-mail program of the present invention. In this routine, when a message is selected or deleted 860, references to it and its tokens are removed 870 from the tokens database. When the user wants to find other messages similar to a specified message, the client performs a statistical analysis 880 on the message comparing it to other messages whose tokens are in the database. The list of most similar messages is presented 890 to the user.

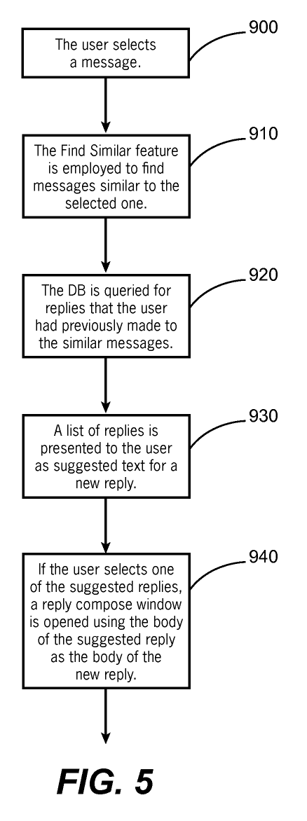

Yet another novel feature of the e-mail program of the present invention is a feature for automatically suggesting reply text for a specified message. The method steps are set out in FIG. 5. The auto-reply feature suggests reply text based on a user's past reply history. When a message is selected 900 for Auto-Reply suggestions, the client first employs the Find Similar feature 910 to get a list of messages that are similar to the one being replied to. It then looks 920 for replies the user made previously to these messages and presents 930 a list of the most likely candidates to the user. The suggested replies are presented to the user in the form of buttons with the subject line of the suggested reply. Clicking a button will open a “Reply Compose” window 940 with the text of the suggested reply as the body of the new reply. The user may then edit the suggested reply text before sending. The maximum number of suggested replies is configurable.

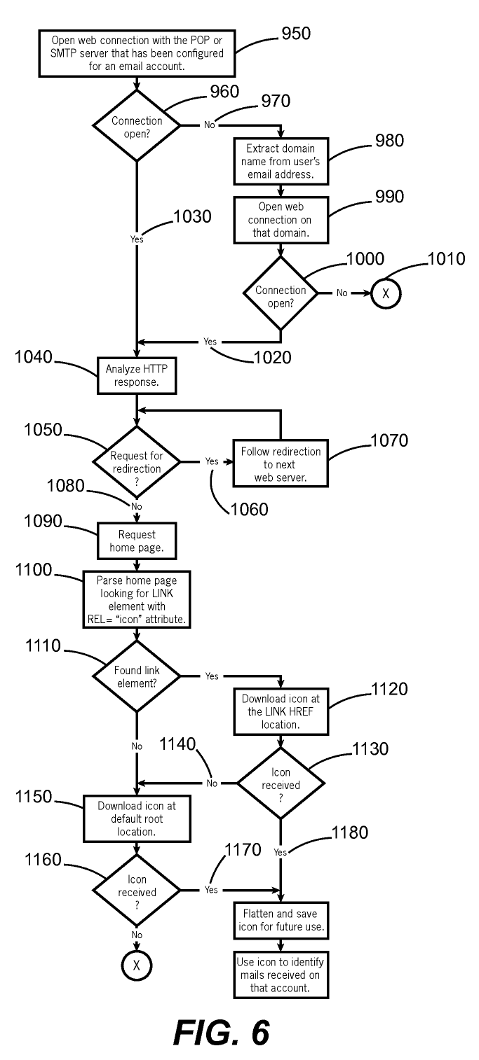

In yet another inventive feature, bearing the descriptive title of “Mail Account Icon,” the inventive program graphically identifies the account of origin of an e-mail by tagging it with the ISP's web icon. The method steps are set out in FIG. 6.

The problem solved by the Mail Account Icon arises from the fact that e-mail users frequently have several e-mail accounts. While contemporary e-mail programs are capable of aggregating several accounts into a common interface, a user faces various problems: either all the e-mails are presented indiscriminately and the user therefore cannot identify the account of origin; or the e-mails are presented in separate containers, one per account, and the user is forced to navigate through each one; or the e-mails are tagged with the name of the account which does allow to identify the provenance of the mail but results in a cluttered interface.

There are several benefits in using an icon over a clumsy name: (1) the origin of the e-mails can be immediately identified even within a long list, thus allowing the user to more efficiently organize and prioritize the incoming correspondence, (2) the icon takes much less space than a verbose label, thus leaving the user more space on the computer screen to display other relevant information that cannot be represented graphically (typically the sender's name and the subject line), and (3) the icon, since it is provided by the ISP, stays the same across the different machines that the user has access to, thus presenting the user with a more consistent interface. These benefits come at zero cost to the user since the feature automatically retrieves the ISP's web icon solely based on the end-user's e-mail configuration.

The Mail Account Icon commences when a web connection is open 950 with the POP or SMTP server configured for an e-mail account and the task looks 960 to see whether a connection is open. If a connection is not detected 970, the domain name is extracted 980 from the user's e-mail address or mail server's address, and a network connection is open 990 on that domain. The task checks again 1000 whether a connection is open, and if not, the task is terminated 1010. If the connection is found open 1020, the task moves to the next step, which is that employed if a connection is initially detected 1030. In either case, the Mail Account Icon feature implements a mechanism where an HTTP request is issued 1040 to these servers with possible requests HTTP re-directions 1050 from the ISP's e-mail-specific domain to the ISP's web domain. If a request for redirection is received 1060, the redirection is followed 1070 to the next network server; if not 1080, then the ISP's home page is requested 1090, and when received it is analyzed 1100 to extract the location of its web icon. When the link element is found 1110, the icon is downloaded 1120 at the hyperlink reference element (HREF) location. At decision block 1130, the task checks to see whether the icon has been received, and if block 1140 is “no,” it is treated the same as if the link element were found in the first instance at step 1110; namely, the icon is downloaded at block 1150 at the default root location. The task again checks at block 1160 to see if the icon has been received, and if block 1170 is “yes,” it is treated the same as if the initial check at step 1130 returned a yes 1180, which entails that the icon be flattened and saved for future use 1190. Thereafter, the icon can be used to identify mail received on the account 1200. If the icon is never received, the task is terminated at block 1210.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like.

Therefore, the above description and illustrations should not be construed as limiting the scope of the invention, which is defined by the appended claims.

What is claimed as invention is:

1. An e-mail message management system having an Inbox and a message deferment feature for postponing the time for taking action on incoming mail message until a specified future time, thereby reducing clutter in said Inbox, wherein said deferment features removes selected messages in said Inbox and places the removed messages in a deferred message mailbox where they remain until a predetermined deferment time expires, and when the deferment time expires the deferred messages are automatically moved back to the Inbox and marked as unread.

2. The e-mail system of claim 1, wherein message deferments feature may be cancelled at any time by the user, wherein when a deferment is cancelled, any messages acted on by the message deferment feature are moved to the Inbox.

3. The e-mail system of claim 1, wherein messages that have been deferred by said deferment feature are marked graphically to indicate the number of times they have been deferred.

4. The e-mail system of claim 1, wherein for IMAP accounts, message deferment information is stored in a special folder on an IMAP server, wherein e-mail clients on remote computers sharing the same IMAP account will be notified of message deferment actions.

5. A method for deferring taking action on e-mails received in an e-mail program Inbox, said method comprising the steps of:
(a) receiving an e-mail message in a receiving e-mail Inbox;
(b) electing to defer taking action on the received e-mail;
(c) selecting a deferment time;
(d) updating the received e-mail message deferment time field in the e-mail program database;
(e) incrementing the received e-mail message deferment count in the e-mail program; and
(f) moving the received message from the Inbox to a Deferred mailbox;

6. The method of claim 5, further including the steps of:
(g) identifying whether the e-mail account is an Internet Message Access Protocol (IMAP) account; and
(h) creating a defer command message and saving it in a special IMAP client synchronization mailbox which identifies the message being deferred, the message's deferment time and its updated deferment count.

7. The method of claim 6, wherein if the account is identified as not an IMAP account, then steps (g) and (h) are bypassed.

8. The method of claim 5, further including the step of:
(I) manually cancelling the deferment on a previously deferred message by selecting the message in the Deferred mailbox;
(j) clearing in the database the deferment time for the selected message; and
(k) moving the selected message to Inbox.

9. The method of claim 8, wherein when the e-mail account is an IMAP account, the method includes the further steps of:
(l) creating a cancel deferment command message and saving it in the IMAP client synchronization mailbox, which identifies the message whose deferment is being cancelled and includes the message's updated deferment count.

10. The method of claim 9, wherein wen the e-mail account is not an IMAP account, step
(l) is bypassed.

11. The method of claim 5, further including the step of
(m) periodically checking the deferment times of messages stored in the Deferred mailbox using a background task;
(n) bringing a deferred message to the user's attention when its deferment time expires.

12. The method of claim 11, wherein when a message deferment time expires, the method includes the following further steps:
(o) marking the message as unread;
(p) clearing the database of the deferment time for the expired field in the e-mail program database; and
(q) moving the message to the Inbox.

13. The method of claim 12, wherein when the e-mail account is an IMAP account, the method includes the further following steps:
(r) creating a clear-deferment command message and saving it in the IMAP client synchronization mailbox, which identifies the message with a deferment being cleared, and includes an updated deferment count for the message.

14. The method of claim 13, wherein when the e-mail account is not an IMAP account, step (r) is bypassed.

15. The method of claim 5, further including step of:
(s) processing remote commands for any IMAP accounts of the e-mail program.

16. The method of claim 5, further including the step of:
(t) using an auto-filing task to automatically suggest folders to which a user may wish to file an e-mail message.

17. The method of claim 16, wherein the auto-filing task of step (t) includes the following sub-steps:
(t1) automatically filing incoming e-mail messages based on a discernible pattern of categorization;
(t2) learning over time the user's filing habits by statistically analyzing the messages in the user's folders;
(t3) analyzing incoming messages to determine which category or categories to which they most likely belong; and
(t4) suggesting folders corresponding to the categories identified in step (t3).

18. The method of claim 17, wherein step (t2) includes the step of processing auto-file commands, including learn, relearn, unlearn, and classify.

19. The method of claim 17, further including the step of:
(t5) rechecking existing messages for correct classifications.

20. The method of claim 17, including the further steps of:
(u) checking to see if the command queue contains an auto-filing command;
(v) if the result of step (u) is yes and a message has been copied to a mailbox, then sending a learn command to the auto-filing task;
(w) performing a statistical analysis on the message; and
(x) adding the results of step (w) to a corpus data file corresponding to the mailbox in which the message was copied.

21. The method of claim 20, wherein if the result of step (u) is no and the received message was moved from one mailbox to another, the method includes the steps of:
(y) sending a relearn command to the auto-filing task;
(z) performing a statistical analysis on the message; and
(aa) adding the results of step (z) to the corpus data file corresponding to the destination mailbox;
(bb) removing the results from the corpus data file corresponding to the source mailbox.

22. The method of claim 17, wherein when a user wishes to forget about a message, the following further steps are included:
(cc) sending an unlearn command to the auto-filing task.
(dd) performing a statistical analysis on the message; and
(ee) removing the results of step (dd) from the corpus data file corresponding to the mailbox.

23. The method of claim 17, wherein when the user wants to know how to auto-file a message, the method employs the following additional steps:
(ff) sending a classify command to the auto-filing task when the client wants to know how a message should be auto-filed;
(gg) performing a statistical analysis on the message;
(hh) comparing the results of step (gg) to the data stored in the various corpus data files; and
(ii) returning a list of the closest matching mailboxes to the requesting task.

24. The method of claim 5, further including the step of:
(jj) finding messages similar to the source message.

25. The method of claim 24, wherein step (jj) bases its similarity findings on the occurrence of common words that appear in the bodies of the messages.

26. The method of claim 24, further including the step of:
listing messages found in step (jj) for quick viewing.

27. The method of claim 26, wherein messages found to be similar to a source message is selected as a new source message and step (jj) is repeated for the newly selected source message.

28. The method of claim 5, further including the step of:
(kk) removing references to a message it is selected or deleted; and
(ll) removing the message tokens from the tokens database.

29. The method of claim 5, further including the step of:
(mm) automatically suggesting reply text for a specified message.

30. The method of claim 29, wherein step (mm) suggests reply text based on a user's past reply history.

31. The method of claim 30, wherein when a message is selected for Auto-Reply suggestions, the e-mail program performs the following additional steps:
(nn) finding a list of messages similar to the one being replied to;
(oo) looking for replies the user made previously to the messages located in step (nn); and
(pp) presenting a list of the most likely reply candidates to the user.
